(19) United States
(12) Patent Application Publication
(10) Pub. No.: US 2018/0165171 A1
(43) Pub. Date: Jun. 14, 2018

(54) Data and Analytics for Observation Platforms

(71) Applicant: Theatro Labs Inc., Richardson, TX (US)

(72) Inventors: Guy R. VanBuskirk, Spicewood, TX (US); Shiva Cheedella, Plano, TX (US); Steve Lucy, Dallas, TX (US); Ravi Shankar Kumar, Plano, TX (US); Kranthimanoj Nagothu, Richardson, TX (US); Sridhar Kovuri, Hyderabad (IN); Vigneshwaran Selvaraj, Bangalore (IN); Bhaskar Chidambaram, Tamil Nadu (IN); Kiran Kumar Shankar Belambi, Karnataka (IN)

(21) Appl. No.: 15/377,719

(22) Filed: Dec. 13, 2016

(51) Int. Cl. G06F 11/22

(52) U.S. Cl. CPC G06F 11/2257

(57) ABSTRACT

Methods and system for generating performance information are disclosed. A communication is received from a first device in an environment at a computer system wherein the communication comprises communication data and secondary data. The communication is relayed from the computer system to a second device based on the computer system interpreting the communication data and secondary data. Device performance data is collected regarding the first device based on the computer system interpreting the communication data and secondary data. Analytics are applied to the device performance data to generate summary performance indicators and metrics at the computer system. The summary performance indicators and metrics are made available.

### BACKGROUND

Modern communication devices provide for many communication and business analytics opportunities in retail, hospitality, industrial and other settings. Many modern communication devices are diverse and have wireless connectivity options. The wireless connectivity options may or may not follow standard protocols. Additionally, many different types of devices, systems, and/or objects may be networked including devices with electronics, software, sensors, and connectivity to enable the devices to collect and gather data to be exchanged over the network. Communication devices may transmit errors that need correcting. Other support issues may also arise related to communication devices used in a setting.

### BRIEF DESCRIPTION OF THE DRAWINGS

FIG. 1 is a block diagram illustrating an observation platform according to an example of the present technology.

FIG. 2 is a block diagram illustrating a plurality of observation platforms according to an example of the present technology.

FIG. 3 illustrates a block diagram for data and analytical process for an observation platform according to an example of the present technology.

FIG. 4 is a flowchart of an example method for generating performance information according to an example of the present technology.

FIG. 5 is a block diagram that provides an example illustration of a computing device that may be employed in the present technology.

### DESCRIPTION OF EMBODIMENTS

Reference will now be made in detail to embodiments of the present technology, examples of which are illustrated in the accompanying drawings. While the technology will be described in conjunction with various embodiments, it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving,” “storing,” “relaying,” “executing,” “generating,” “determining,” “collecting,” “applying,” “making available,” or the like, refer to the actions and processes of a computer system, or similar electronic computing device. The computer system or similar electronic computing device, such as a wearable computer, telephone, smart phone, tablet computer, handheld mobile device, or other connected IoT device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer system technologies such as, for example, optical, quantum and mechanical computers.

A user or users, as referred to herein, may be a person or people such as, sales associates, employees, managers, trainees, trainers, doctors, clinicians, patients, customers, emergency responders, personnel, etc. In one embodiment, the user interfaces with a device for communications with other users or interaction with external systems. Such a device may be a handheld device, a headset, a smartphone, a tablet, an earpiece, a radio, a computer system, or other device capable of providing communications across the network. Such users may be part of the enterprise operating the observation platform or they may be external to the operating entity (e.g., customers, shoppers or visitors) and desire access to users, information or control of devices within the attached data network.

Customers or visitors may refer to anyone within the environment of an observation platform who are not directly connected to the observation platform system but may do so by using the wearable devices or other applications (apps) designed to connect by permission and arrangement directly with the observation platform. In one embodiment, customers or visitors may refer to individuals who are purchasing or shopping for items or services in store or hospitality environment, past customers, potential customers, perspective customers, shoppers, browsers, or others who enter the store environment as a potential client and not with the same operational access an employee does.

An observation platform may be a set of networked mobile devices communicating with a central computer system that is used to monitor, relay, structure, or otherwise supervise communications between users or computer systems. The observation platform at the same time collects information about the communications and the users of the networked mobile devices and about the technical performance of the systems and platform in near real-time. The central computer system may be a single computer system, may be a plurality of computer systems working in tandem, or may rely on cloud computing techniques.

For the users, the observation platform facilitates communication between a limitless number of mobile or wearable devices and external systems using speech recognition, context and policy as a method for determining how devices are connected, what is heard, what is displayed, and what functions are performed.

A single observation platform generally covers a single geographic area such as a store, hotel, warehouse or event venue. Observation platforms may be networked together allowing transparent connections between geographies so that users and systems operate as if they were within a single geographic zone or within a single observation platform.

The wearable device or networked mobile device is a personal communicator that connects users with each other, relevant computer systems, external networked devices, Internet of Things (IoT) devices, beacons and third party devices such as cellphones, smartphones, tablets, or other commercially available communicating equipment. In one embodiment, networked mobile device is a specific purpose device built for use in the observation platform. In one embodiment, the networked mobile device may not include a graphical user interface and instead relies on audio communications and physical hardware buttons. The software associated with or executing on the wearable devices monitors, extracts information, and transmits an extensive set of data relative to the performance of the device and it's interaction with the surrounding systems and connections to the observation platform itself.

Devices other than the wearable device or networked mobile device, such as walkie-talkies or independent smartphones, may also be used within an observation platform through an Application Program Interface (API) developed for the observation platform. The performance monitoring of those devices will depend on the extent of the data available through the API or from interactions with the network and computer portions of the observation platform.

Large-scale deployments of multiple observation platforms increases the burden on support activities and increases the support costs if statistical measures are not employed. The present technology reduces the operational costs, improves performance, and increases reliability by using near-real-time statistical modeling of devices, processing the data in a rules engine using custom criteria and history for determination of alerts and suggestive actions. Because of the scale of potentially hundreds of devices operating within hundreds of interconnected observation platforms, a traditional model of break-fix support would be ineffective and expensive.

Within the observation platform the users perform their tasks and communicate with each other or with other systems without realizing that with each communication, and also at periodic intervals, a data set of performance factors is also transmitted. The actions, commands, and locations of the users are part of the data collected and transmitted. Additional data is gathered regarding the hardware and software performance of the wearable devices, commercial devices, external systems, IoT devices and the supporting network and radio systems. In one embodiment, the composite of the collected data forms the basis for the analysis of data and subsequent alarm generation or corrective suggestions presented to the platform operators.

The present technology assists with deploying and supporting thousands of wearable devices or networked mobile devices distributed across many observation platforms in many physical environments. In one embodiment, effective management and support of a large number of devices may be accomplished by extensive data collection and analysis of that data to track objective, real-time performance of all devices within and connected to the observation platform and identify real or potential issues through direct interpretation of the incoming data, statistical means, forecasted trends, and predictive maintenance practices.

Waiting for a user to report a problem or for a device to fail, would frustrate users and increase support costs. In order for an observation platform to be reliable and economically cost effective, the system infrastructure includes extensive data from each device, historical performance information and other data from external systems. In one embodiment, the wearable devices or beacon devices of the present technology are purpose-built to provide extensive data regarding system performance and device performance within the region of the observation platform.

### Overview of Data and Analytics for Observation Platforms

The present technology employs an observation platform for structured communications and for gathering or collecting statistics about the users, devices and external systems that may connect to the observation platform. The following overview describes how an observation platform is used for communications between devices and computer systems and is used for collecting statistics from devices, communications and computer systems. Individual details, embodiments, and components of the observation platform described herein may or may not be used for embodiments pertaining to using observation platform to measure and quantify user performance scores, grades, benchmarks, or rankings.

Embodiments of the present technology are for systems and methods for utilizing detailed device performance and technical data gathered to facilitate deployment, support and maintenance activities within an observation platform. In addition to providing detailed operational information for the system, the data and analytics also provides insight and potential corrective actions for the experience of each user. The data originates from the software running on purpose-built wearable devices or from a proprietary applications running on standard commercially available devices operating in communication with the observation platform. The data originating from the wearable and mobile devices may undergo processes including statistical modeling, anomaly and threshold detection, prioritization and dispatch. The result is a data-driven support capability that improves system availability and assists operators in the diagnosis and correction of problems based on the unique data being delivered by the wearable devices within the observation platform and the unique ability to process that data into meaningful performance indicators and metrics.

Using structured communications in an observation platform, as referred to herein, may refer to the following actions regarding communications between two or more users or one user and one or more computer systems: mediating, intercepting, disciplining, structuring, controlling, participating, discouraging, encouraging, influencing, nudging, making an example of, permitting, limiting, managing, validating for compliance with policies, measuring what goes on as a communication occurs, characterizing, enabling, observing, recording, correcting, directing, informing, requesting, alerting, etc.

Embodiments of the present technology are for an observation platform using structured communications including communication with external devices and systems. An observation platform may involve a number of users and provides structured and disciplined communications for the users and associated devices as well as captures data regarding the communications such as user context and device or system performance metrics. The present technology may be employed in various environments such as retail settings, public-stage floors, outdoor venues, concerts, police scenarios, disaster areas, schools, sporting events, hospitality operations, hospitals, clinics, security operations, military operations, a prison organization, customer service centers, call centers, manufacturing organizations, a factory floor, warehouse operations and other environments where humans work together, with external computer systems or other IoT devices and where communications occur between users and/or the external systems or devices.

The mediating, structuring, or disciplining process envisioned herein involves using a computer system as an observation platform to receive communications, performance data, or instructions from users, devices, external devices, IoT devices, and computer systems. The observation platform will then serve to generate or parse metadata related to the communication, performance, or instruction; and to relay, forward, delay or inhibit the communication or instruction based on the context of each user, device or system.

Communications may be enabled or initiated using multiple techniques including but not limited to simply speaking commands, saying names, asking questions, issuing commands, press-to-talk broadcasting to groups or segments of the observation platform, or talking to specific groups or locations. A user of a device may listen to pre-established information (e.g., podcasts, messages, announcements, huddles, chat-ins or enterprise related info-casts), by moving the device into locations where information is presented or requested based on location and context of the user or proximal device. Listening to information from other users on the system may be in either real-time or delayed. Listening to information from other systems or processes within this system may be related to actions required or information necessary to work more efficiently. In one embodiment, the system, including other users, may prompt users for verbal contributions to the data store or seek selected button presses to determine further context or supplemental information and actions of the user. For example, a user may enter a geographic region within the environment of the observation platform that triggers the device to play pre-established information. The user may then be required to respond to a question or prompt contained in the pre-established information. In one embodiment, in conjunction with the communications and signaling information being exchanged, the observation platform collects other relevant data which may include signals or sounds useful for location determination; sounds useful for system optimization; sounds useful for user identification, role determination, or environment detection; or other signal information (audible, sub-audible, or optical) relevant to operating in the desired environment.

### Data and Analytics for Observation Platforms

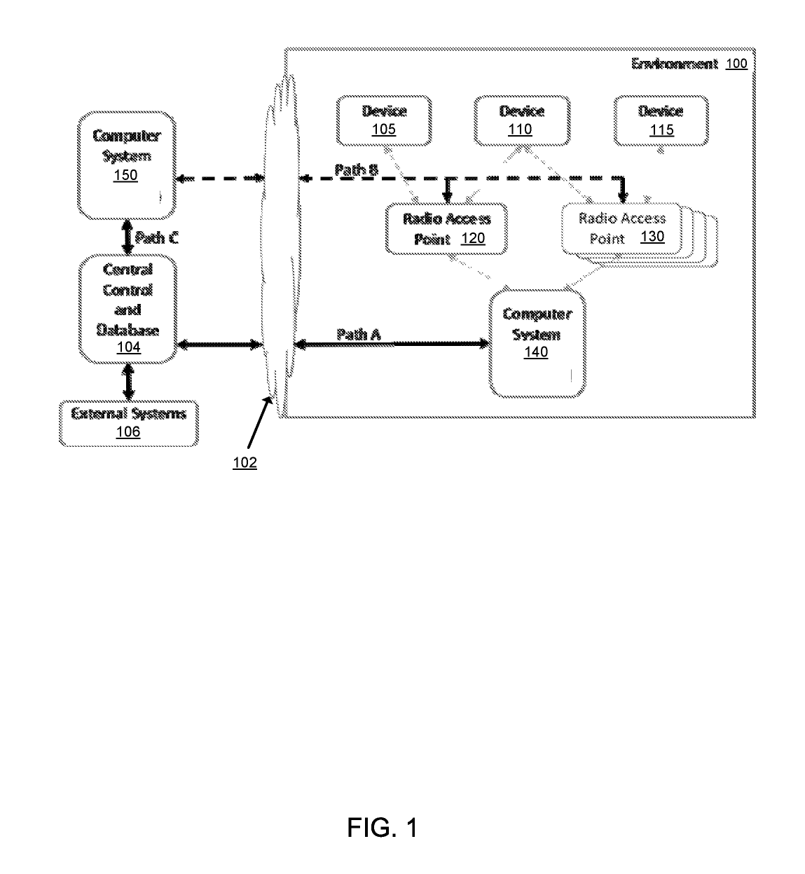

With reference now to FIG. 1, a block diagram of an observation platform. An environment 100 describes a physical location of a basic observation platform. Within the environment 100 are devices 105, 110, 115 which each represent one or a plurality of communication devices. It should be appreciated that the observation platform may comprise any number of communication devices. These communication devices may communicate using wireless signals connecting to radio access points 120 and 130 within the environment 100. The radio access points 120 and 130 depict antennas or other transceivers associated with the observation platform that can send or receive wireless communications. The devices 105, 110, 115 may be owned by the enterprise associated with the observation platform, owned by the user, or owned by the observation platform provider and may be, for example, a smartphone, a tablet computer, a wearable device, a personal digital assistant, a fob, a handheld device, a headset device, or other small electronic device.

The devices 105, 110 and 115 may be user devices that are mobile and employed by a user to communicate with other users via other devices. Communications between the devices 105, 110 and 115 may be described as signals. In one embodiment, the devices 105, 110 and 115 employ speakers and microphones with control buttons for audible communications. The control buttons may be press to signal buttons, push to talk buttons, volume control buttons, and power on/off buttons or other standard buttons and may be options on a touchscreen. The devices 105, 110 and 115 may be handheld, may be worn around the neck, and may be a headset worn on the head or behind the ear or otherwise interface with the human body. The devices 105, 110 and 115 may or may not comprise a screen or display such as a liquid crystal display (LCD) or touch screen. In one embodiment, devices 105, 110 and 115 do not comprise a display such that a user is not inundated with too many options or too much information from the device. A user device without a display may simplify communications and thus allow heads-up awareness and presence in the environment. Another user, such as a customer, may be more likely to employ the device for its intended purpose if the human interface is simplified.

The devices 105, 110 and 115 and other devices in environment 100 may be dispensed to a user upon entering environment 100 or may be brought by the user into environment 100. For example, in a retail setting associates may be issued devices by the employer or owner of the retailer setting. Customers in the retail setting may also be issued devices as they enter the retail setting. Customers may choose whether to accept the device or whether or not to use the device after accepting it. The devices 105, 110 and 115 may represent more than one type of communication device. For example, associates or employees of the environment associated with the observation platform may or may not use the same type or model of devices as customers of the environment. Alternatively, the customer may bring a device into the retail setting such as a smartphone. The customer may download an app to the smartphone that will allow the customer to use the device for communications in the store with associates or others in accordance with present technology. The customer may remain anonymous or may elect to identify themselves. In one embodiment, recognition of the customer's identity is not required for additional services or offers.

The environment 100 may comprise multiple radio access points 120 and 130 and access point technology may include Wi-Fi, Bluetooth, private radio or other wireless connections. An environment and may contain a single or a plethora of radio access points as shown. In one instance, a computer system 140 exists within the environment 100, and by using standard computer networking technologies such as switches, bridges, routers, firewalls, gateways, etc., the radio access points communicate with each other and with the computer system 140. The computer system 140 communicates via standard networking technologies, possibly including the internet, to the central control and a database such as central control and database 104 using bi-directional Path A. Path A may pass through network 102 which may be the internet, a local network, or another network. The computer system 140 may comprise more than one computer system and may be optional in the physical location of environment 100. For example, the computer system 140 may rely on cloud computing techniques with computing systems or resources located in remote network.

In an embodiment where the computer system 140 is not included in environment 100, Path B is used to communicate between the radio access points 120 and 130 and a computer system 150 that is an external computer system, that may reside in the cloud, in the enterprise, or at the service provider for the observation platform. In one embodiment, the environment 100 relies on a computer system such as the computer system 140 or the computer system 150 in order to operate. It is possible to conFIG. an observation platform with both computer system 140 and computer system 150 connected for purposes of redundancy or to share computational load.

The radio access points 120 and 130 and the devices 105, 110, 115 may employ standard techniques for communicating wirelessly. The communications may be performed using radio techniques such as near field communications, short wave radio, infrared, Bluetooth, WiFi, standard wireless computer network protocols, etc. The devices 105, 110 and 115 may be able to communicate with each other directly or through access points 120 and 130. The devices 105, 110 and 115 communicate with each other via the computer system 140 or 150. In one embodiment, all communications in the environment 100 are relayed through the radio access points that act as a central hub. For example, the device 105 may communicate with the device 110 by the device 105 sending a communication to the radio access point 120, the computer system 140 derives that the device 110 is the destination for the communication and relays the communication to device 110. This may occur automatically and quickly enough such that the users will not experience any undue lag in communications. In one embodiment, the devices 105, 110, and 115 may communicate directly with the computer system 140. For example, a user may issue a command to the computer system 140 via the device 105 or the computer system 140 may send information to the device 105. Information send from the computer system 140 to the device 105 may be an audible voice signal or may be textual, contextual, geographical or graphical data to be displayed at the device 105 if it is properly equipped to do so.

The computer systems 140 or 150 are responsible for the structuring of communications and collection of analytical data from the devices 105, 110, and 115. The computer system 140 or the computer system 150 report data to the central control and database 104 using either Path A or Path C as indicated. Additionally, the central control and database 104 may provide information, instructions, messages, configuration data, and/or policy information to the computer system 140 or the computer system 150 for structuring and controlling the communication flow to and among the Devices within Environment 100. The central control and database 104 contains the instructions for policy distribution to the computer system 140 or the computer system 150. The central control and database 104 accumulates the primary statistics and processes the algorithms for generating the secondary statistics and Higher-order Statistics used to determine system health and user performance.

The central control and database 104 may reside with the provider of the observation platform, in the cloud, within the enterprise or in a commercially available server farm facility. The central control and database 104 may provide one or more Application Programming Interfaces (APIs) to any external systems 106 and information sources that may communicate with the users and devices within Environment 100. The central control and database 104 also provides encrypted and secure storage and access to computer systems 140 or 150.

External systems 106 may refer to external computer systems owned by the enterprise, third-party services, vendors or suppliers, or the provider of the observation platform. The external systems 106 may contain information that is pushed to users of the observation platform such as time-clock alerts, video analysis alerts, cross-channel or omni-channel support alerts, enterprise-wide or group-targeted messaging text or audio, automated status alerts or other information that would be useful to one or more users of the observation platform(s).

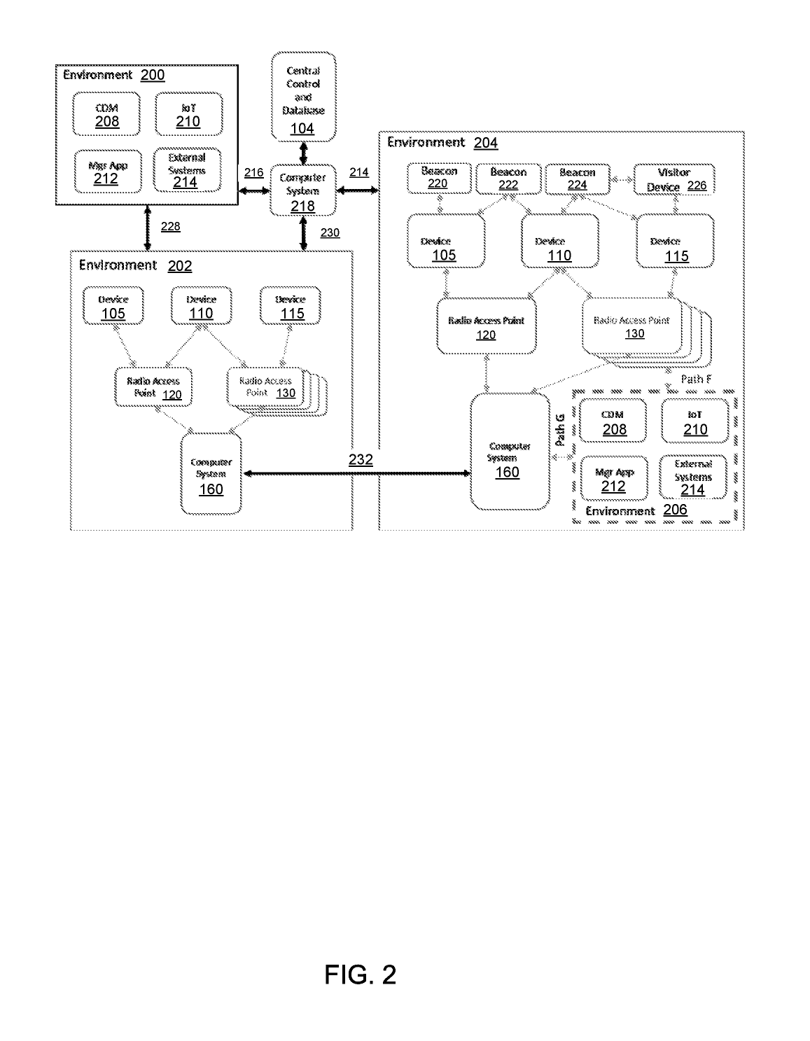

With reference now to FIG. 2, a block diagram of observation platforms including environments 200, 202, and 204. The environments 202 and 204 may comprise some or all of the features of environment 100 of FIG. 1. As compared to FIG. 1, FIG. 2 depicts additions of interconnections between observation platforms such as environments 202 and 204. FIG. 2 as adds a new environment depicted as environment 206, within the observation platform depicted as environment 204, that contains one or more systems or alternate devices such that may interact with the devices 105, 110, and 115 within environment 204 and hence users of the system. FIG. 2 also adds; attaching a new environment depicted as environment 200 that contains one or more systems or alternate devices, such a CDM 208, an IOT 210, a mgr app 212, and external systems 214, that may interact with the devices 105, 110, and 115 of environments 202, 204, or other observation platforms and hence users of the system. It should be appreciated that environment 206 may also comprise a unique set of a CDM 208, an IOT 210, a mgr app 212, and external systems 214.

Interconnection of observation platforms allows information to be exchanged and structured across any set of locations, buildings, cities, or countries. The observation platforms, depicted in the environment 202 and 204, are usually connected under the control of the computer system 218 via path 214 and path 230. In one embodiment, the observation platform of environment 204 may directly communication with the observation platform of environment 202 via path 232. The computer system 218 mediates the communication between the sites, applies policy to the transiting information, and extracts statistical information for application to Secondary or Higher-order statistics used for performance evaluation of users or the system integrity. The computer system 218 may have features and capabilities and a purpose similar to the computer system 150 of FIG. 1. Environment 204 shows in detail how other devices within an observation platform environment can interact with user devices 105, 110 and 115, the radio access points 120 and 130, and the computer systems 160 and 218.

Beacon devices 220, 222, and 224 are typically small fixed or mobile devices that emit a signal to alert other devices that they are within a near proximity of the beacon. The beacon signal may contain identification information or other information useful to the receiving device. For example, visitor device 226 may detect the beacon 222 that causes a visitor device 226 to contact a separate system to receive special offers or information regarding the local proximity. The user devices 105, 110 and 115 of the environment 204 may be capable of receiving the beacon signal that may be used for proximity detection and location determination. Additionally, user devices 105, 110 and 115 of the environment 204 may be capable of transmitting a beacon signal to trigger actions in devices carried by visitors or shoppers. For example, the visitor device 226 may detect a beacon signal from the device 115 which causes the visitor device 226 to contact a separate system that in turn alerts the user of the device 115 that they are in proximity to a specific visitor or shopper along with information about that visitor or shopper. The observation platform might then communicate with an external system (e.g., external system 214 of environment 200 or 206) to receive instructions and potential offers for that visitor or shopper.

The environment 206 depicts a set of other possible devices that may reside either within the observation platform as shown in environment 204, or external to the observation platform environment as shown with environment 202 which is connected with path 228.

In one embodiment, the CDM 208 is a content distribution manager (CDM) browser that is a software application that is accessed via a uniform resource locator (URL) by any computing device that employs a web browser. The CDM 208 may comprise an application program interface (API) or graphical interface that is employed by a user of the CDM 208. A user of the CDM 208 may be required to provide authentication to access the CDM 208.

The CDM 208 is employed by a user to manage and control messages that are sent to a plurality of observation platform and the devices therein. In one embodiment, the CDM 208 can retrieve content for a message or can be employed to generate new and original content for a message. In one embodiment, the content is an audio file such as a WAV file that is the recording of an audible voice such that when the message is delivered to and accessed by a destination device, the message will playback the audible voice. The CDM 208 may be employed by a manager to record a voice message that is then delivered to a plurality of devices.

In one embodiment, a message controlled by the CDM 208 is delivered to a plurality of devices simultaneously. This may be accomplished by the CDM 208 sending out the message to the various devices at the same time, or CDM 208 may deliver the message to a plurality of observation platforms with commands or instructions to deliver the message to specified devices within the observation platform at a designated time. Delivering the messages to the devices may also be described as pushing the message. The manager using the CDM 208 may designate the time a message should be available for the users and how long that message should be available to hear (end time). Alternatively, the CDM 208 may be employed to deliver the same message to different devices at different times. For example, the message may be delivered to store managers within a set of observation platforms at a designated time before the message is delivered to other employees within the same set of observation platforms. The user of the CDM 208 may also specify that additional content or messages are sent to different devices. For example, additional content may be sent to store managers or additional content may be sent to devices associated with a specific department in a retail setting such as the painting department.

In one embodiment, the CDM 208 is employed to specify who or what devices are to receive the message with its content. For example, the user of the CDM 208 may have authority over several different environments each with its own observation platform. The user may wish that the message only be sent to specified observation platforms within the plurality of observation platforms. Alternatively, the user may specify that all of the devices within all of the observation platforms receive the message, or only devices located within the physical boundaries of the observation platform at the designated time receive the message, or only devices associated with a specific department receive the message or only devices associated with store employees and not customers receive the message. The possible options for specifying which devices receive a message and when are limitless. A message may also be generated and sent to a specific individual. In one embodiment, the CDM 208 uses groupings by role, department, district, and/or region to determine which devices play a given message. It should be appreciated that the content of the message may be a voice recording, but may also be other content such as text, images, or video. In one embodiment, the message is sent to a given device with a command to notify the user of the device that there is a message received. The notification may be a light, a blinking light, a specific color of light, a sound, a textual notification, or any other type of notification that the device is capable of providing.

The CDM 208 may be employed by a user that has high level access to the plurality of observation platforms. For example, a corporation may have hundreds or thousands of hospitality locations or store fronts that each makes use of an observation platform. The corporation may have a headquarters or central office with employees who have access to the CDM 208 with the ability and authority to send a message to anyone and everyone associated with the corporation.

In one embodiment, a device that receives a message from the CDM 208 automatically sends a confirmation back to the CDM 208 that the message has been received. Additionally, once the message has been accessed or heard by the user of the device, the device may send a message back to the CDM 208 that the messaged has been heard or otherwise accessed. In one embodiment, the message may be a mandatory message that the user of the device is required to access a, listen to and then acknowledge hearing.

Another possible element of environment 206 is the manager application depicted as mgr app 212. In one embodiment, the mgr app 212 is a software application or app that is accessed via a mobile computer system such as a smartphone or tablet. In one embodiment, the mobile computer system executes an Android operating system. In one embodiment, the mobile computer system executes an iOS operating system. Other operating systems may also be employed. The mgr app 212 may be an app available for download and installation on the mobile computer system. The mgr app 212 is designed with an API or graphical interface specific to a mobile computer system such as a smart phone and to be used in the field by a user or manager associated with at least one observation platform. The user of the mgr app 212 may be a regional manager that has access to a plurality of observation platforms. The regional manager may regularly travel between the physical locations of the plurality of observation platforms and needs to have access to the observation platforms while physically remote and in the field on the go. The mgr app may also be used by corporate headquarters personnel and by support personnel for either the enterprise or third party support of the enterprise.

In one embodiment, the mgr app 212 allows the user of the mgr app 212 to communicate with or monitor any device or plurality of devices within any of the observation platforms associated with the user. The mgr app 212 also is able to report statistics or observe or monitor communications with any of the observation platforms associated with the user. For example, the mgr app 212 may be able to listen in to communications happening in real time within an observation platform or may be able to play back past recorded communications. In one embodiment, the manager application may operate in a manner identical to the mobile devices in the observation platform as a peer-like device. In this mode the manager application may broadcast or direct communications to specific devices, receive alerts and provide both a primary signal for communication and a secondary signal for determining geographic location. In one embodiment, the peer-like device may be able to operate and interact with devices within an observation platform without directly communicating with a central computer system. In other words, the central computer system may or may not be required for receiving and relaying messages from the manager application. The mgr app 212 may also be employed to send announcements or messages similar to the CDM 208. The mgr app 212 may communicate directly through a network with a given observation platform or may use the external communications paths 214, 216, and 230.

Another possible element of environment 206 is an Internet of Things (IoT) device depicted as IoT 210. An observation platform may be associated with external devices including a growing list of electronic devices that communicate with each other or with one or more systems providing status, alerts and other useful command/control information. These external devices are able to operate in an observation platform and communicate using formatted data strings and standard internet protocols for communication across the internet. These external devices may be referred to as the Internet of Things (IoT).

Specifically, IoT 210 depicts a wide array of IoT devices that can use the observation platform for alerting selected users of actions needed or that may query selected users for additional information or may query the observation platform for user contextual information or may allow users to instruct or control the IoT devices based on user context and policy. Environment 206 comprises components that may or may not be used with different embodiments of the present technology and should not be construed to limit the present technology.

The present technology provides for many examples of how structuring communications may be used in various environments for a variety of purposes. The following discussion will demonstrate various hardware, software, and firmware components that are used with and in computer systems and other user devices for structuring communications using various embodiments of the present technology. Furthermore, the systems, platforms, and methods may include some, all, or none of the hardware, software, and firmware components discussed below.

One purpose of structuring or disciplining a communication is for users to become more productive and more effective customer service associates or sales people in a retail or hospitality setting. The present technology may accomplish this goal by monitoring communications of the users that occur via communication devices. The communications may be monitored to derive context information from the communication such as the name of the user; geographic location of a user; the state or status of the user (e.g., busy, available, engaged, conversing, listening, out-of-range, not logged on, etc.); the user's interaction with others; proximity to other users, visitors, beacons, cellular phones or other electronic signals; commands or instructions from the user to external devices; instructions or requests from external devices to the user; how the user responds, both physically and verbally, to those instructions or requests.

An observation platform may be associated with external devices including a growing list of electronic devices that communicate with each other or with one or more systems providing status, alerts and other useful command/control information. These external devices are able to operate in an observation platform environment and communicate using formatted data strings and protocols for communication using the Application Programming Interface (API) for the observation platform. These external devices form a diverse group of equipment that may be referred to as the Internet of Things (IoT). Other devices within the observation platform may use radio techniques such as Bluetooth or Bluetooth Low Energy (BLE) to signal their presence and information. These devices are sometimes called “beacons” and may be used for triggering actions on the wearables, smartphones or other devices carried on a person.

In one embodiment, the structured communications of the observation platform allows users to directly and immediately interact with external devices through the mechanisms of the observation platform such as: interpretation and recognition of spoken words (e.g., speech-to-text speech recognition), geographic location determination provided by the observation platform, proximity location provided by external cues (e.g., a beacon, environmental sounds, sub-audible sounds, RF signals or optical trigger) and optional identification of end users, their roles, assigned tasks, primary locations and individual responsibilities.

The external devices may collect and gather data via sensors such as cameras, motion sensors, heat sensors, door counters, proximity sensors, beacons, temperature sensors, etc. Additional data may be collected from the wearable devices or mobile devices related to the technical performance of those devices within the platform. The collected data may be exchanged via a network such as the network associated with the observation platform or via separate connections or networks. Moreover, the observation platform may be able to make inferences from communications, performance data, and locations within the observation platform as well as make inferences from the data gathered by the external devices. The inferences may then be combined with policy and used to structure the communications and/or structure the control or requests from the external devices or take other actions within the observation platform. The technical performance indicators and metrics may be statistically modeled, analyzed, prioritized and dispatched based on the criteria defined in the system.

An observation platform is used to connect enterprise users with each other and connect the users with external devices and computer systems associated with the observation platform. Policy, as accepted or determined by the controlling enterprise, determines the most appropriate action for commands to other users or external devices, or requests from other users or external devices. The policy can use information such as, but not limited to: location, history, recognition of spoken words and optional personal identification including roles and responsibilities, plus any information provided by the external system, to dynamically determine and control how communications, commands, information or other requests and responses are routed through the system and presented to the users or external devices.

The users of the observation platform carry or wear devices capable of capturing the person's voice, surrounding information such as sounds and sub-audible sounds, detailed device performance information, electronic signals or optical signals. Sub-audible sounds may or may not be made by a human user but are sounds that are out of the range of normal human hearing. Electronic signals may be any radio (RF) device or beacon which emits a radio signal that is received by the user wearable device regardless whether the signal is demodulated or understood by the user device. The wearable device develops a second signal from the surrounding information which is used by the observation platform to determine the nature of the external device, the location of the device and indicative of the current context of the associated user. The device may be a commercially available device or, may be a specific purpose device built for the present technology normally using a button that is pressed to capture the user's voice when specific actions are desired by the user.

The communications, motions and behaviors of users within the observation platform may be monitored to derive context and user behavioral information from the raw statistics gathered by the system. Many raw statistics are used to dynamically determine source and, separately, destination context by the system and are selected from the group raw statistics such as: engagement time; available times; location maps for the enterprise layout; listen time and who or what was listened to; talking time on the system; non-system directed talking time as detected by the wearable; number and role of listeners to messages sent to the system; urgency of listeners to hear a message from the user; geographic location of devices and users; locations traversed including speed and direction; time in-zone and not-in-zone; who initiated communications to which individuals, groupings of individuals or external systems; type of communication (e.g., broadcast, private individual, private group, announcement, voice-to-machine, machine-to-user, initiate requests for actions, respond to requests for action etc.); length of communication; location of initiating communications; locations of receiving communications; intonation; speech pacing; lengths of speeches; lengths of speech segments; when, where, and for how long two or more users dwell in close proximity to each other or to specific locations; speed of movement and pausing of listening individuals during/after talking or listening to another user or a connected system; frequency that listeners delay hearing a message, drop out from what a speaker is saying, or delete a message before hearing it from a user; questions asked and how long the question takes to ask; questions answered, and how long it takes to respond and then answer the question; action requests initiated from users or external systems, action requests responded to from users or external systems, from where, to where and any associated motions; promptness of responses to what was heard from users or from external systems, button presses and button press durations as initiated by the user; which policies are invoked by the observation platform for the communications between users or external systems.

Context determination is the result of the analysis of the raw statistics within the observation platform and using the default or explicit policy of the enterprise to determine the most appropriate recipient of information from either users or external devices, or where and when to most appropriately deliver messages, communications, commands, requests or instructions to users or devices.

The structuring or disciplining process described herein involves using a communications and computer system as a platform to first, build a context and contextual history of each user or device based on actions, motions, instructions, reactions and behaviors within the observation platform, and second, use policy and inference to make determinations for distributing information, instructions or voice files; collecting information; generating requests for actions; accepting and playing requests for action; generating or distributing instructions or indicators from users or external systems; or delivering information, requests, instructions, indicators, a user's voice, or other audible messages to other users or other external systems.

For example, the observation platform may listen to commands from users, interpret those commands, establish two-party and multi-party communications links, pass on messages, and store messages and commands for later action. Commands from users, internal rules and policies, or external systems may indicate the need for specific assistance at specific locations and policy may determine how many and which users hear the request or which external systems are issued instructions. The interpretation of commands may also be relayed or forwarded to the external devices as instructions to that device or plurality of devices. A response by a user or external system may be voluntary or mandatory, based on policy, and is processed by the observation platform using current context, historical context, inference and policy to determine the most appropriate actions. Data is collected about each step of the process thereby permitting an owner or manager or a group of people to observe and analyze the effectiveness of the group's interactions with each other and with external systems. Aggregating the data and employing analytical tools within the observation platform can result in performance information for each user of the system, groups of users, wearable device and external systems.

The communications may be monitored by a computer connected to the observation platform which is associated with a data network that acts as a conduit for the user communications, primary statistics, actions and reactions of users and devices. The data network may consist of, but is not limited to: wireless connections (typically, but not exclusively WiFi), wired connections, optical connections, switches, routers, firewalls, encryption devices, private networks, internet segments, cloud-based segments and enterprise-owned servers.

The computer system may convert audible, voice or speech communications to text or machine-compatible format using standard and well-known speech recognition techniques. Decoding the spoken words may determine commands, identify keywords, and initiate actions based on the words spoken and the button that is pressed at the time of speaking. The decoded text in combination with location or proximity to other devices may be used to derive additional context information from the communication. The computer system may also store some or all of the communication including the audible portion of the communication, the context of the user, the decisions made by inference and policy, and the decoded text of the communication.

The computer system may also be in communication with the external systems, external devices or IoT devices and have the ability to issue instructions to the external devices or receive instructions from the external devices. Instructions may be requests for action, responses to instructions or information that is useful to the user or the connected system.

The computer system also terminates, intercepts or relays the portion of the signal related to the device and system performance data. The device performance data is reported by each device or system element as a portion of the secondary signal which contains the other elements such as location described above. The system then applies technical rules and criteria to the device data to generate summary performance indicators and metrics for use by operators or external systems to improve or optimize the user experience. The summary performance data therefore represents a concise numerical set of data defining the objective performance of the device and a quantified measure of the quality of the user experience with the device.

The structured communications may extend beyond a single venue to multiple venues or enterprise locations without regard to geographic spacing. A plethora of observations platforms may be connected via a network and will interoperate according to the programmed policy.

In one embodiment, the computer system uses the context information derived from the raw data combined with policy to determine a destination of the communication and forwards, delays, inhibits, modifies or relays the communication to the destination. For example, a first user may attempt to contact a second user via communication devices. The first user sends the communication to the computer system associated with the observation platform using the network. The computer system recognizes the first user's speech or instruction and is able to derive current context information to add to historical context information for determining that the communication's destination is a third user. The computer system then relays the communication, via the network, to a communication device associated with the third user. The computer system may also convert the communication to text and derive additional instructions or performance metrics regarding the first or third user. For example, the first user may be an associate in a retail setting and the third user is a customer. The first user may be responding to a query made by the third user. The performance metric may be the length of time it took for the first user to respond to the query, how long it took to respond to the query, whether or not the query was satisfied, the geographic location of the first user, the geographic location of the third user, the proximity between the users, or may be a different metric entirely. The computer system may derive and store more than one performance metric for each communication exchange.

In one embodiment, the computer system generates or parses metadata related to a communication and also knows metadata for each of a plurality of devices in the observation platform. The computer system is then able to match an attribute of the metadata from the communication to an attribute from the metadata of at least one of the plurality of devices in the observation platform. The communication may then be forwarded to the matched device(s). The metadata may be described as attributes, tags, or characteristics of a communication. The communication may be a signal generated by user device and may comprise speech, text, audio, video, button-press instructions, or a combination thereof. The attributes of the metadata may not be associated with the content of the signal and are related to context of the signal such as the time the signal was sent, an identification of the device that sent the signal, a location of the device when the signal sent, a geographic zone the device is located in, history of the device sending communication, etc. In one embodiment, the metadata is associated with the content of the signal, such as text. The generating of metadata and relaying of the communication may occur substantially in real time such that a user of the device does not perceive any delay in communications.

In one embodiment, the computer system is able to determine geographic locations of users based on information received from communication devices associated with the users. The geographic location data may be stored as data associated with a user's communications device at a particular time, or as a performance metric, or may be combined with other information to generate a performance metric. The location data is an element of the context of the user or external device and is used by the observation platform for structuring the flow of all information. Geographic information and user motion combined become elements of the user context and are used with policy to determine the source or destination of information processed by the observation platform.

Within an observation platform signals for communicating between wearable devices or between wearable devices and other systems such as Internet of Things (IoT) devices, external databases or other computer systems, are mediated by the computer system as previously described and either terminated at the computer system, intercepted and re-generated for transmission to other devices by the computer system, or relayed to a device or plurality of devices by the computer system. The signals from the wearable devices contain data regarding the performance, location or digitized voice of the user.

The data indicative of device performance can be transmitted from each device either as a separate signal at a separate time, or a portion of a signal carrying a separate set of data that is combined with a signal carrying digitized voice information. Commercially available devices and systems may have performance information available and that performance information may be transmitted from those devices depending on available configurations and the applications that are running on the device.

The data from the wearable devices or other device in the observation platform may include one or more of the following data elements:
Location of a device in the format of an x,y coordinate
Location of a device in the format of zone determined upon system set-up.
Digitized audio files created by the users voice
Accelerometer inertial information regarding device movement in x, y, z directions
LED or indicator status visible to the user of the wearable device
Beacon counts, addresses, codes and function of each beacon detected
Mic gain and AGC settings
Battery charging status
Battery voltage or remaining charge information
Battery temperature
Ambient temperature
Volume setting by the user
Access Point (AP) identification (typically a MAC address)
RSSI information for relevant access points, beacons or WiFi location nodes
On-line/Off-line status for each device
Lost packets
Packet delay
Packet jitter
Reboot detection and counts
Mean Opinion Score (MOS)
Duration of button presses
Software version information

Additional system data indicative of device and system performance can be acquired from network elements such as Access Points (APs), network nodes and the computer system, such as the computer system 218 or 160 of FIG. 2, operating the observation platform. The data from other system components may include one or more of the following data elements:
Out-of-range detection
Reboot detection
Speech recognition word and phrase confidence data
Speech recognition command accept/reject data
RSSI information for relevant access points, beacons or WiFi location nodes
On-line/Off-line status for each device
Lost packets
Packet delay
Packet jitter

The data elements above are intercepted by the computer system during the process of relaying the signal or terminated by the computer system if the purpose of the signal from the device is only to report status and data. The computer system may intercept and/or copy the relevant data elements and continue to relay the composite signal to other device or external systems.

All data elements are collected by the computer system and stored as defined by a data schema that structures the data in tables for immediate analysis or later use. The structured data is then combined through query functions into categories more useful for human operators or other computer systems. As an example, one table may contain information relative to signal strength being received by a device at a given time or during a given transaction between devices. Another table may contain the location information of that device at given time or for a given transaction from that device. A new table may be constructed using information from structured tables of signal strength and location information to create a category of signal strength by location.

Many data elements may be combined from the structured tables to derive categorized information such as a “user experience.” In one example, the system may identify a user through the usual methods and relate that individual's nominal performance information to the user's current activity on the system. It may be that the identified user speaks loudly, works in a region of the observation platform with poor coverage, does not hear very well and speaks with an accent. In this case, the statistical modeling for that user would identify that microphone gain should be reduced (speaks loudly), the anomaly and threshold detection 306 should expect more packet loss, delay and jitter, hence a lower MOS score (poor coverage region), the volume on the user's device should be increased (does not hear very well) and a lower than average speech recognition confidence and accept/reject ratio (speaks with an accent).

Within the observation platform, the structured tables and the categorized device performance information may be further combined with historical data and pattern information to statistically model the current performance of a device or a user experience. Some data elements used within the statistical model may include:
Audio waveform analysis (clipped, noise, saturation)
Speech recognition scores (accept/reject ratio) as determined by the system
Speech recognition confidence as determined by the speech recognition engine
Speech recognition confidence thresholds for acceptance by phrase
Speech recognition confidence thresholds for acceptance by word
Prompts played to the user
Headset failure detection
Transmission durations
IoT commands/responses
System control commands
Device status and available devices (on-line/off-line)
MOS (speech quality) in each direction or end-to-end
Battery status and historical life
User identification
Tap out of commands and command cancels
Time out of commands
End cause for the communication (out-of-range, logoff, cancel, time-out, source ended, target ended, tap-out, interrupt, reboot, etc.)

In one embodiment, the process of statistical modeling, anomaly detection and prioritization might be used to determine the nominal summary performance indicators and metrics for the speech recognition of commands for a plurality of users within and observation platform. In this case, the system will attempt to determine, in the shortest amount of time, if there is a system deficiency that may be lowering the acceptance rate of commands or if the performance is nominal given the current environmental factors. In attempting to statistically model the command accept/reject ratio the sample size of attempted commands determines the time it takes to collect the required samples. The decision criteria used in the statistical model include factors such as:
Dynamic determination of how many command attempts are a significant sample size.
Incorporation of command frequency, past speech recognition patterns, and acceptance rates for each user on the system (accent and in-grammar %).
Computation of the mix of speakers on the system currently and their unique patterns of past usage and performance.
Determination of how long has the each user been using the system as an indicator of being experienced to say in-grammar commands.
Deriving a prediction of the store environmental conditions based on historical data of background noise detection, other voices in the background, user stress, and voice cadence. For example, Saturdays and lunch times are usually noisier and show a lower accept rate for speech commands.
Detection of excessive or anomalous events that skew the data. For example, Brenda joking around with “hello” names or Billy attempting to log-on 22 times.
Comparison of the tap-out rate for each command. For example, if the system shows a high command acceptance rate with a corresponding high tap-out (cancel) rate this means we are falsely accepting commands and may need to increase the confidence threshold for that command.

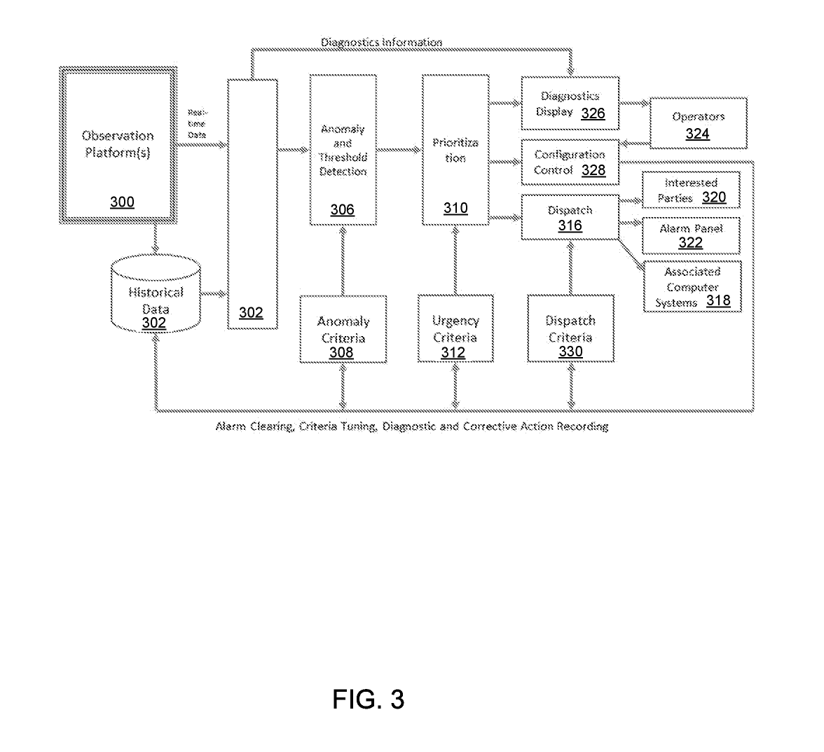

With reference to FIG. 3, a block diagram for data and analytical process for an observation platform. FIG. 3 depicts the components and process used by the computer system to derive the summary performance indicators, metrics, alarms, adaptive configuration parameters, and user experience measurements.

The fundamental source of data used by the analytics system is the derived from the wearable or mobile devices and systems connected within the observation platform 300 as previously described. In one embodiment, most of the data from the observation platform is real-time or near-real-time and is structured in various tables as described for the central control and database 104 of FIG. 2 that oversees each observation platform. A component the central control and database 104 of FIG. 2 is the historical database, which is depicted as historical data 302 in FIG. 3. The central control and historical database may reside locally within the observation platform, remotely within the operating entity, or in the cloud operated by a third party.

In one embodiment, statistical modeling 304, is used to process all technical data prior further analysis, threshold detection, prioritization, display and dispatch. In some cases, the data may not need to be accumulated and analyzed statistically and can be passed directly through this function to the remaining elements of the analysis system. One example of a data stream not usually requiring statistical modeling are the digitized audio files created by the user's voice. These files can be passed directly to the anomaly and threshold detection 306 for instantaneous analysis of such factors as late button presses (frontal phrase clipping), overmodulation (saturation), undermodulation (noisy voice signal), excessive background noise, and early button releases (end clipping).

Typically, the statistical modeling 302 accumulates data from the observation platform 300 and uses data from the historical data 302 to create a statistical array of data that can be used to detect patterns and derive statistical measures of the data array such as standard deviation, median, mode, skew, and other normally used statistical measures. The historical data 302 may accumulate intervals of real-time data from the observation platform and combine that data with the historical data 302 to compare current vs. past performance or to create a more robust dataset for presentation to the anomaly and threshold detection 306.

Statistical modeling may also use information such as time-of-day to structure the current data against one or more of similar times of day, days of week, months of year or special days such as holidays or other event days. It is often necessary to consider the element of time, day, week, month or event to determine what data is nominal for the interval.

Statistical modeling may also use information such as the identity of a user to produce data sets that correspond with that given user's historical performance with the system. The statistical model may consider factors for that given user such as locations usually worked, speech recognition past patterns, device usage patterns and historical communicating patterns as part of the dataset model. The statistical model may then combine a plethora of user models into a consolidated model for any given set of users.

The statistical model may also correlate a known user with information such as a user's role in the enterprise, a user's group memberships, and a user's time on the system. The statistical model may then combine a plethora of user models into a consolidated model for any given set of users.

In one embodiment, the anomaly and threshold detection 306 uses the statistically modeled data from the statistical modeling 302 and applies the anomaly criteria from 308 to determine if the current data set meets the criteria of “nominal” or if the anomaly in the data exceeds a threshold level. A primary function of the anomaly and threshold detection 306 is to allow a sensitive measurement of the data while simultaneously reducing false indications of anomalies or alarms. The anomaly and threshold detection 306 may use additional data accumulated from the statistical modeling 302 to add additional time-averaging, weightings or statistical parameters to process the data such that when compared with the anomaly criteria from 308, a meaningful determination is made regarding the significance of any data excursions.

In one embodiment, the anomaly criteria from 308 is used to define the thresholds or data excursions that would indicate an event to be passed along to the prioritization 310. The criteria may be manually entered by an operator or may be algorithmically created or adjusted by using a sample of corrective actions determined by or entered into the diagnostics display 314.

For example, an anomaly criteria might describe detecting three sequential speech recognition rejects within a period of 45 seconds. In this case, the anomaly criteria includes: the number of speech recognition rejects (such as 3 rejects), the basis of measuring sequentially or allowing other speech recognition accepts between rejects (may be sequential), and the length of time for the inspection period (such as 45 seconds). In another example, the anomaly criteria might include

The prioritization 310 is used to compare the relative importance of an anomaly detected by the anomaly and threshold detection 306 as modified by the anomaly criteria from 308. The importance, hence priority, of an anomaly depends on two factors: 1) the urgency criteria 312, and, 2) the degree to which the anomaly exceeds the anomaly criteria as configured in the anomaly criteria from 308.

The prioritization 310 chooses at least one among three output paths: 1) it can determine the information is interesting or is sufficiently organized to present to the diagnostics display 314; 2) it can determine that the anomaly is of the type that could be affected by algorithmic adjustment of the parameters within the observation platform or algorithmic adjustment of the anomaly criteria from 308; 3) it can determine that the priority is sufficient to send the anomaly information to the dispatch module 316 for ultimate dispatch to people or associated computer systems.

The urgency criteria 312 determines how important an anomaly is for one or more of the types of routings of the data and the dataset excursion: 1) presentation as a diagnostic display to an operator for investigation and action; 2) dispatch to the associated computer systems 318 associated with the observation platform; 3) dispatch to interested parties 320 that may need to know of the anomaly; 4) dispatch to an alarm panel 322; or 5) dispatch to the configuration control 328.

The urgency criteria 312 defines parameters used by the prioritization 310 to determine the significance of an anomaly. Some examples of urgency criteria include: 1) grouping anomalies by system impact such as anomalies that affect the quality of the voice across the system would take precedence over an anomaly that might affect the accuracy of the location tracking. Another example might be that an important user or a user with an important role in the enterprise might be experiencing poor speech recognition. If the user status or role is critical or important within the enterprise, a relatively minor anomaly in the speech recognition acceptance rate might be escalated to the operators 324 who are support operators or even the alarm panel 322.

The urgency criteria 312 may consider other subjective criteria such as the importance of given store or enterprise site, the time-of-day and if the time-of-day is a critical period in the operation of the enterprise, the location of a given user and if that location is critical to the operation of the store or enterprise, or a combination of subjective and objective criteria for determining the importance of the data anomaly.

The diagnostics display 314 receives data and information from both the statistical modeling 302 and the prioritization 310. The function of the diagnostics display 326 is to present to operators and support personnel a concise and well-structured display of the data and information useful for assuring the system is operating nominally, or in the case of an abnormal data excursion, a concise display of the relevant parameters regarding the anomaly.

The operators 324 or support personnel use the diagnostic display as a key indicator in determining if any actions are useful and for deriving corrective actions when appropriate. The corrective actions may include such activities as 1) notifying users that they are not properly using the mobile or terminal devices; 2) notifying system-level contacts that there are issues in network connectivity or remote server (computer) operations and supporting any changes with updated data; 3) adjustment of data thresholds or the anomaly criteria; or 4) adjusting how the observation platform operates by changing policy or control parameters via the configuration control 328.

If the operators 324 or support personnel takes action to adjust any policy, control or configuration parameters, the actions taken are appended to the historical data 302 for use in subsequent statistical models or diagnostic displays.

The configuration control 328 can take in information from either the prioritization function 310 or directly from system the operators 324 or support personnel. If the information is from the prioritization function, the configuration control 328 determines via internal polices, rules and algorithms, if a configuration change would improve the behavior of the overall system and improve the user experience or the system performance. The configuration control 328 is capable of adjusting the system control parameters without user or operator intervention. Adjustments made by the configuration control 328 are recorded in the historical data 302 for tracking/audit purposes or for use in subsequent statistical modeling.

The prioritization 310 can determine that the dispatch 316 needs to be invoked to disseminate information or alarms to one or more of: 1) interested parties 320, associated computer systems 318 or alarm panel 322. The dispatch 316 is responsible for analyzing the data-set from the prioritization 310 and sending only relevant portions of the data-set or a summary of the data set to the appropriate external functions by using the rules of the dispatch criteria 330.

The dispatch criteria 330 provides the rules, policies and guidelines for determining: 1) which external systems or interested parties receive a notification of the anomaly; 2) the information and content of the message, 3) how the message is formatted; 4) how the message is delivered; and 5) when the message is delivered. The dispatch criteria can be adjusted by manual operator instructions or changes to the criteria or may be adjusted algorithmically by the configuration control 328 in response to operator actions or its analytical determination that the criteria for dispatch should be altered.

In one embodiment, the dispatch criteria 330 includes instructions that, for example, if the quality of the voice communications degrades with sufficient priority as determined by prioritization 310, the dispatch 316 would assert an alarm on the alarm panel 322, would send samples of the degraded voice to an associated computer systems 318 for analysis and logging, and would notify a store manager by using an audible message through the wearable or mobile device via the interested parties 320.

The dispatch 316 may send formatted information to interested parties 320 through a wide set of media and communication channels. Some methods used by the dispatch criteria 330 include: SMS messaging, voice messaging to phones, smartphone applications, portals connected via the internet, pagers, or via wearables or mobile devices connected within an observation platform. When the formatted information is sent to one or more users within an observation platform, the information may be sent as immediate in-ear audible messages, audible messages that can be played at will, or visual messages on smart devices. Multiple dispatches and types of dispatches may be created for a single event.

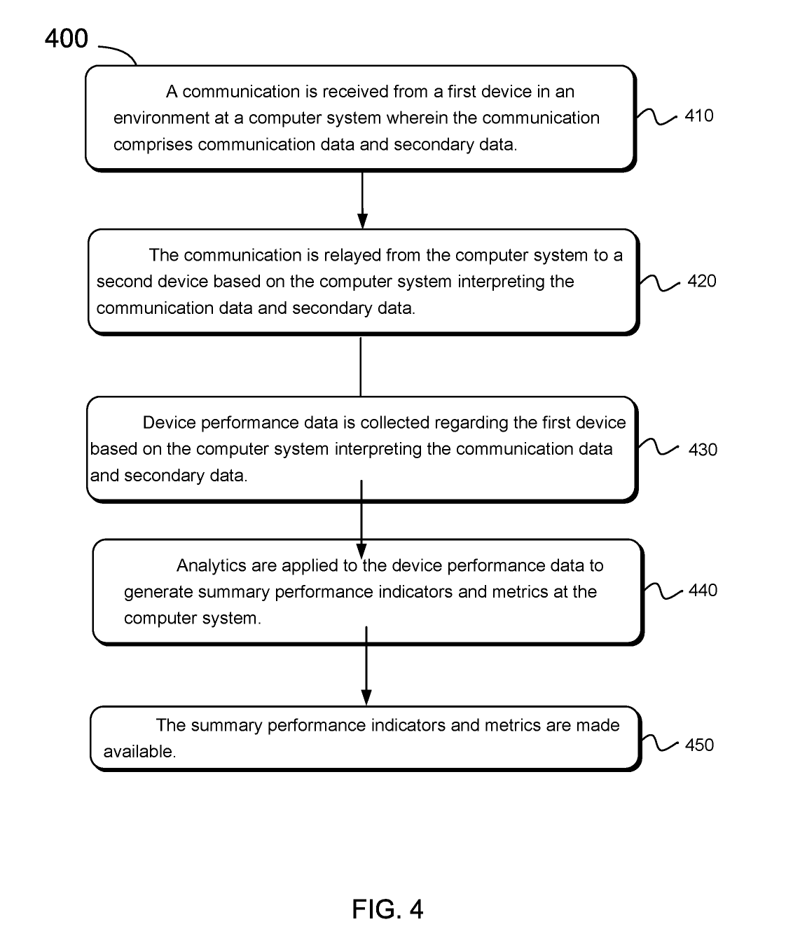

FIG. 4 is a flowchart of an example method 400 for generating performance information according to an example of the present technology. The functionality 400 may be implemented as a method and executed as instructions on a machine, where the instructions are included on at least one computer readable medium or one non-transitory machine-readable storage medium. For example, starting in block 410, a communication is received from a first device in an environment at a computer system wherein the communication comprises communication data and secondary data. The communication is relayed from the computer system to a second device based on the computer system interpreting the communication data and secondary data, as in block 420. Device performance data is collected regarding the first device based on the computer system interpreting the communication data and secondary data, as in block 430. Analytics are applied to the device performance data to generate summary performance indicators and metrics at the computer system, as in block 440. The summary performance indicators and metrics are made available, as in block 450.

In one embodiment, the summary performance indicators and metrics are made available to users, operators, external computer systems, support systems, and/or third parties based on a dispatch criteria.

In one embodiment, the summary performance indicators and metrics are prioritized and dispatched as an alarm.

In one embodiment, the summary performance indicators and metrics are presented as diagnostic information for maintenance and troubleshooting performance issues with the first device.

In one embodiment, statistical modeling is applied to the device performance data or user experience data to remove at least one false indication of anomalies.

In one embodiment, statistical modeling using historical data related to the first device is applied to the device performance data to detect deviations from normal performance.

In one embodiment, statistical modeling is applied to the device performance data and uses time-of-day information to detect data that is not within normal limits for a given time interval.

In one embodiment, statistical modeling is applied to the device performance data and to historical data to detect data that is not within normal limits for a given set of users.

In one embodiment, statistical modeling is applied to the device performance data and to historical data to adapt a configuration parameter of the system.

In one embodiment, an urgency criteria is applied to prioritize a significance of the device performance data that is not within normal limits.

In one embodiment, the urgency criteria is based on a role of a user of the first device.

In one embodiment, the urgency criteria is based on a location of the first device.

In one embodiment, the prioritized data is presented to an operator for diagnostic and corrective actions.

In one embodiment, process 400 further comprises receiving corrective actions from an operator wherein the corrective actions are based on prioritized data used to adjust the first device.

In one embodiment, the corrective actions are added to historical data for the first device.

In one embodiment, prioritized data based on the device performance data is presented to a dispatch function for distribution to interested parties.

In one embodiment, the dispatch function distributes the prioritized data as in-ear messages to a selected set of user devices.

In one embodiment, the relaying the communication from the computer system to the second device is further based on a speech to text analysis of audible data associated with the communication data.

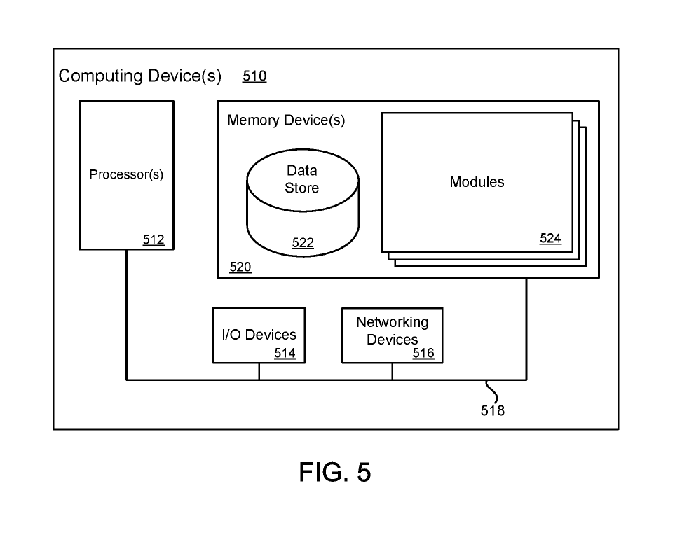

FIG. 5 illustrates a computing device 510 on which modules of this technology may execute. A computing device 510 is illustrated on which a high level example of the technology may be executed. The computing device 510 may include one or more processors 512 that are in communication with memory devices 520. The computing device may include a local communication interface 518 for the components in the computing device. For example, the local communication interface may be a local data bus and/or any related address or control busses as may be desired. For example, the computing device 510 may be computer system 140, 150, 160, or 218, or devices 105, 110, or 115 of FIGS. 1 and 2.

The memory device 520 may contain modules 524 that are executable by the processor(s) 512 and data for the modules 524. The modules 524 may execute the functions described earlier. A data store 522 may also be located in the memory device 520 for storing data related to the modules 524 and other applications along with an operating system that is executable by the processor(s) 512.

Other applications may also be stored in the memory device 520 and may be executable by the processor(s) 512. Components or modules discussed in this description that may be implemented in the form of software using high programming level languages that are compiled, interpreted or executed using a hybrid of the methods.

The computing device may also have access to I/O (input/output) devices 514 that are usable by the computing devices. An example of an I/O device is a display screen that is available to display output from the computing devices. Other known I/O device may be used with the computing device as desired. Networking devices 516 and similar communication devices may be included in the computing device. The networking devices 516 may be wired or wireless networking devices that connect to the Internet, a LAN, WAN, or other computing network.

The components or modules that are shown as being stored in the memory device 520 may be executed by the processor 512. The term “executable” may mean a program file that is in a form that may be executed by a processor 512. For example, a program in a higher level language may be compiled into machine code in a format that may be loaded into a random access portion of the memory device 520 and executed by the processor 512, or source code may be loaded by another executable program and interpreted to generate instructions in a random access portion of the memory to be executed by a processor. The executable program may be stored in any portion or component of the memory device 520. For example, the memory device 520 may be random access memory (RAM), read only memory (ROM), flash memory, a solid-state drive, memory card, a hard drive, optical disk, floppy disk, magnetic tape, or any other memory components.

The processor 512 may represent multiple processors and the memory 520 may represent multiple memory units that operate in parallel to the processing circuits. This may provide parallel processing channels for the processes and data in the system. The local interface 518 may be used as a network to facilitate communication between any of the multiple processors and multiple memories. The local interface 518 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configuration definitions, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed:

1. A method for generating performance information, comprising:
receiving a communication from a first device in an environment at a computer system wherein the communication comprises communication data and secondary data;
relaying the communication from the computer system to a second device based on the computer system interpreting the communication data and secondary data;
collecting device performance data regarding the first device based on the computer system interpreting the communication data and secondary data;
applying analytics to the device performance data to generate summary performance indicators and metrics at the computer system; and
making the summary performance indicators and metrics available.

2. The method as recited in claim 1 wherein the summary performance indicators and metrics are made available to users, operators, external computer systems, support systems, and/or third parties based on a dispatch criteria.

3. The method as recited in claim 1 wherein the summary performance indicators and metrics are prioritized and dispatched as an alarm.

4. The method as recited in claim 1 wherein the summary performance indicators and metrics are presented as diagnostic information for maintenance and troubleshooting performance issues with the first device.

5. The method as recited in claim 1 wherein statistical modeling is applied to the device performance data to remove at least one false indication of anomalies.

6. The method as recited in claim 1 wherein statistical modeling using historical data related to the first device is applied to the device performance data to detect deviations from normal performance.

7. The method as recited in claim 1 wherein statistical modeling is applied to the device performance data and uses time-of-day information to detect data that is not within normal limits for a given time interval.

8. The method as recited in claim 1 wherein statistical modeling is applied to the device performance data and to historical data to detect data that is not within normal limits for a given set of users.

9. The method as recited in claim 9 wherein statistical modeling is applied to the device performance data and to historical data to adapt a configuration parameter of the system.

10. The method as recited in claim 1 wherein an urgency criteria is applied to prioritize a significance of the device performance data that is not within normal limits.

11. The method as recited in claim 10 wherein the urgency criteria is based on a role of a user of the first device.

12. The method as recited in claim 10 wherein the urgency criteria is based on a location of the first device.

13. The method as recited in claim 1 wherein the prioritized data is presented to an operator for diagnostic and corrective actions.

14. The method as recited in claim 1 further comprising:
receiving corrective actions from an operator wherein the corrective actions are based on prioritized data used to adjust the first device.

15. The method as recited in claim 14 wherein the corrective actions are added to historical data for the first device.

16. The method as recited in claim 1 wherein prioritized data based on the device performance data is presented to a dispatch function for distribution to interested parties.

17. The method as recited in claim 16 wherein the dispatch function distributes the prioritized data as in-ear messages to a selected set of user devices.

18. The method as recited in claim 1 wherein the relaying the communication from the computer system to the second device is further based on a speech to text analysis of audible data associated with the communication data.

19. A non-transitory machine readable storage medium having instructions embodied thereon, the instructions when executed cause a processor to perform a method for generating performance information, the method comprising:
receiving a communication from a first device in an environment at a computer system wherein the communication comprises communication data and secondary data;
relaying the communication from the computer system to a second device based on the computer system interpreting the communication data and secondary data;
collecting device performance data regarding the first device based on the computer system interpreting the communication data and secondary data;
applying analytics to the device performance data to generate summary performance indicators and metrics at the computer system; and
making the summary performance indicators and metrics available.

20. A system for generating performance information, the system comprising:
a processor and memory configured to:
receiving a communication from a first device in an environment wherein the communication comprises communication data and secondary data;
relaying the communication to a second device based on the computer system interpreting the communication data and secondary data;
collecting device performance data regarding the first device based on the computer system interpreting the communication data and secondary data;
applying analytics to the device performance data to generate summary performance indicators and metrics at the computer system; and
making the summary performance indicators and metrics available.
